(19) United States
(12) Patent Application Publication
(10) Pub. No.: US 2025/0276462 A1
(43) Pub. Date: Sep. 4, 2025

(54) PERSONAL HYGIENE TOOL

(71) Applicant: TECHTRONIC CORDLESS GP, Anderson, SC (US)

(72) Inventors: Shi Jie XIA, Dongguan City (CN); Chi Wai TAM, Dongguan City (CN)

(21) Appl. No.: 19/047,104

(22) Filed: Feb. 6, 2025

(30) Foreign Application Priority Data
Mar. 4, 2024 (EP) 24161266.2

(51) Int. Cl. B26B 21/52; A45D 27/22; B26B 21/40

(52) U.S. Cl. CPC B26B 21/521; A45D 27/22; B26B 21/405; B26B 21/4062

(57) ABSTRACT

A personal hygiene tool comprises a handle extending along a first axis and comprising an opening formed at a first end, where a plurality of recesses are formed within the opening; and a tool head attachment at least partially retained within the opening and rotatable with respect to the handle around a second axis; wherein the tool head attachment comprises a latching mechanism comprising: a sliding latch slideable between an extended position where the sliding latch protrudes into one of the plurality of recesses and a retracted position where the sliding latch is disengaged from the recesses; a resiliently deformable element arranged to urge the sliding latch towards the extended position; and a first actuator configured to urge the sliding latch towards the retracted position against the resiliently deformable element.

### FIELD OF THE DISCLOSURE

The present disclosure relates to personal hygiene tools and, in particular, to a personal hygiene tool with a rotatable tool head attachment.

### BACKGROUND OF THE DISCLOSURE

Personal hygiene tools may encompass a wide variety of tools used for a large number of tasks in, for example, skin care, hair care, beauty and dental hygiene. It is conventional for such tools to have an elongated handle to be held by the user. Depending on the tool, it may be better for the tool head to be aligned with the longitudinal axis of the handle, set at a right angle to the longitudinal axis of the handle, or set at some other angle in between.

For example, a shaver will generally be arranged with the blade assembly aligned with the longitudinal axis of the handle, while a dermaplaner blade is usually set at a right angle to the longitudinal axis of the handle.

For some tools, such as a hair trimmer, it may be more comfortable and more stable to set the tool head at a different angle, depending on where the hair trimmer is used.

There is therefore a need for a personal hygiene tool with a rotatable tool head attachment.

### SUMMARY OF THE DISCLOSURE

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with a first aspect of the present disclosure, there is provided a personal hygiene tool comprising: a handle extending along a first axis and comprising an opening formed at a first end, where a plurality of recesses are formed within the opening; and a tool head attachment at least partially retained within the opening and rotatable with respect to the handle around a second axis. The tool head attachment comprises a latching mechanism comprising: a sliding latch slideable between an extended position where the sliding latch protrudes into one of the plurality of recesses and a retracted position where the sliding latch is disengaged from the recesses; a resiliently deformable element arranged to urge the sliding latch towards the extended position; and a first actuator configured to urge the sliding latch towards the retracted position against the resiliently deformable element.

The first actuator may include a user-depressible button movable along the second axis.

The first actuator may include a camming surface set at an angle to a movement direction of the first actuator, and the camming surface is arranged to engage with the sliding latch and urge the sliding latch in a direction perpendicular to the movement direction of the first actuator.

The sliding latch may be an elongate element slideable along its length in a plane perpendicular the second axis.

An outer edge of each recess and a protruding end of the sliding latch may be bevelled or rounded.

The first actuator may be configured to urge the sliding latch to a point between the extended position and the retracted position where the sliding latch is partially engaged with one of the plurality of recesses.

The plurality of recesses and a protruding end of the sliding latch may have a circular form.

The personal hygiene tool may include a blocker which is engageable with the sliding latch in the extended position to prevent the sliding latch from moving towards the retracted position.

The personal hygiene tool may include a second actuator configured to move the blocker from an engaged position where the blocker is engaged with the sliding latch to a disengaged position where the blocker is disengaged from the sliding latch.

The second actuator may include a user-depressible button movable along the second axis, where an activation direction of each actuator is along the second axis towards the other actuator.

The personal hygiene tool may include a second resiliently deformable element arranged between the first actuator and the second actuator to resist movement in the respective activation direction of each actuator.

The plurality of recesses may be arranged in an arc extending in a plane perpendicular the second axis.

The handle may include five recesses spaced equally apart.

The tool head attachment may defines a third axis extending between the second axis and a working point of the tool.

The sliding latch may be arranged to extend at 45 degrees to the third axis.

The second axis may be perpendicular to the first axis.

The tool may be a shaver, trimmer or scraper.

The tool head attachment may include a blade or blade assembly.

In accordance with a second aspect of the present disclosure, there is provided a personal hygiene system comprising a personal hygiene tool and at least one of a charging base formed to support the personal hygiene tool thereon and provide power to the personal hygiene tool; and a charging case formed to hold the personal hygiene tool inside and provide power to the personal hygiene tool. The personal hygiene tool comprises a handle extending along a first axis and comprising an opening formed at a first end, where a plurality of recesses are formed within the opening; and a tool head attachment at least partially retained within the opening and rotatable with respect to the handle around a second axis. The tool head attachment comprises a latching mechanism comprising: a sliding latch slideable between an extended position where the sliding latch protrudes into one of the plurality of recesses and a retracted position where the sliding latch is disengaged from the recesses; a resiliently deformable element arranged to urge the sliding latch towards the extended position; and a first actuator configured to urge the sliding latch towards the retracted position against the resiliently deformable element.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended Figures. Understanding that these Figures depict only exemplary embodiments of the disclosure and are not therefore to be considered to be limiting of its scope, the principles herein are described and explained with additional specificity and detail through the use of the accompanying Figures.

Preferred embodiments of the present disclosure will be explained in further detail below by way of examples and with reference to the accompanying Figures, in which:—FIG. 1 is a perspective view of a personal hygiene tool according to an embodiment.

FIG. 2 is a perspective view of the personal hygiene tool.

FIG. 3 is a disassembled view of the personal hygiene tool.

FIG. 4 is a lateral section schematic of a first end of the personal hygiene tool.

FIG. 5 is a longitudinal section schematic of the first end of the personal hygiene tool according to a first embodiment.

FIG. 6 is a longitudinal section schematic of the first end of the personal hygiene tool according to a first embodiment.

FIG. 7 is a longitudinal section schematic of the first end of the personal hygiene tool according to a first embodiment.

FIG. 8 is a perspective view of a first actuator according to a second embodiment.

FIG. 9 is a longitudinal section schematic of the first end of the personal hygiene tool according to a second embodiment.

FIG. 10 is a perspective view of the second actuator according to a second embodiment.

FIG. 11 is a perspective view of the first end of the personal hygiene tool, according to a second embodiment.

FIG. 12 is a partially disassembled view of a tool head attachment of the personal hygiene tool according to a second embodiment.

FIG. 13 is an oblique section schematic of a tool head attachment of the personal hygiene tool according to a second embodiment.

FIG. 14 is a lateral section schematic of the first end of the personal hygiene tool.

FIG. 15 is a partially disassembled view of a blade holder of the personal hygiene tool.

FIG. 16 is a perspective view of the personal hygiene tool with a charging base.

FIG. 17 is a disassembled view of the charging base.

FIG. 18 is a plan view of the personal hygiene tool with a charging case.

FIG. 19 is a disassembled view of the charging case.

FIG. 20 is a perspective view of a kit including the personal hygiene tool, charging base and charging case.

### DETAILED DESCRIPTION OF THE PREFERRED EMBODIMENTS

Various embodiments of the disclosure are discussed in detail below. While specific implementations are discussed, it should be understood that this is done for illustration purposes only. A person skilled in the relevant art will recognize that other components and configurations may be used without departing from the scope of the disclosure.

FIG. 1 is a perspective view of a personal hygiene tool 1 according to an embodiment. FIG. 1 shows a personal hygiene tool 1 comprising a handle 100 and a tool head attachment 200.

The handle 100 extends along a first axis. The first axis may be referred to as a longitudinal axis of the tool. The handle 100 may be generally cylindrical.

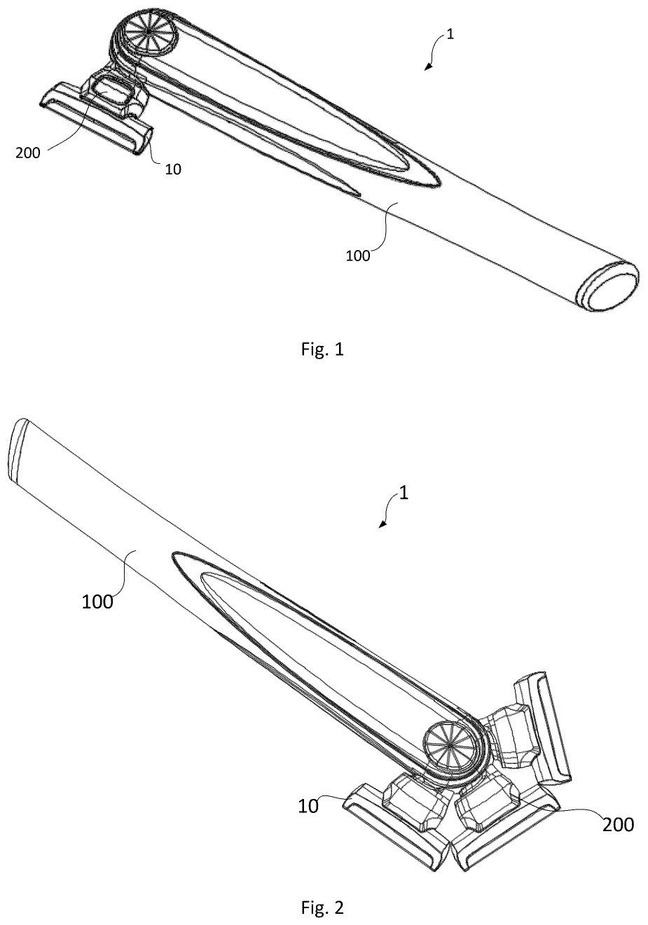

FIG. 2 is a perspective view of the personal hygiene tool 1. As illustrated, the tool head attachment 200 is rotatable with respect to the handle 100 around a second axis. The second axis may be perpendicular to the first axis. The second axis may be referred to as a transverse axis of the tool.

The tool head attachment 200 may be configured to rotate through a maximum arc of 90 degrees. In some examples, the maximum rotation arc of the tool head attachment 200 may be smaller than 90 degrees, or may be larger than 90 degrees up to a maximum of around 180 degrees. The tool head attachment 200 may rotate in one direction only from a starting position in which the tool head attachment 200 is aligned with the first axis. The tool head attachment 200 may rotate symmetrically in either direction from the first axis.

The tool head attachment 200 may be configured to rotate to a plurality of fixed positions. The fixed positions may be equally spaced along the arc of rotation or may be distributed unevenly e.g. with an increasing or decreasing spacing between each position. As shown, the number of fixed positions may be five. In some examples, there may be a greater or lesser number of fixed positions.

The personal hygiene tool 1 may be a shaver, trimmer, scraper, dermaplaner or any other personal hygiene tool. In some examples, the personal hygiene tool 1 may be a dental hygiene tool e.g. a toothbrush or flosser, or a hair care tool e.g. a curling or straightening iron, or a beauty tool e.g. nail clipper, nail buffer, eyelash curler, eyebrow razor or threading tool. The tool head attachment 200 may include a blade or a blade assembly 10. The blade assembly 10 may be a static blade assembly with one or more blades or a moving trimmer assembly. The blade assembly 10 or other tool head may be fixed to the tool head attachment 200 or may be replaceable. The tool head attachment 200 may be configured to fit a plurality of different tool heads.

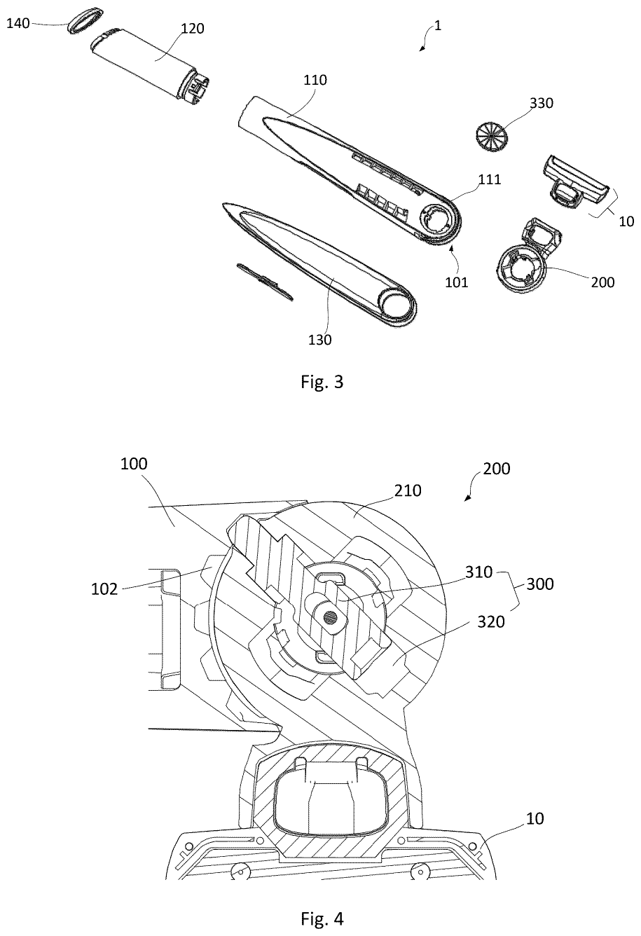

FIG. 3 is a disassembled view of the personal hygiene tool 1. The handle 100 comprises an opening 101 formed at a first end. The tool head attachment 200 is at least partially retained within the opening 101.

The handle 100 may be formed with a front handle portion 110, a rear handle portion 120, and an outer grip 130. The front handle portion 110 may form the first end of the handle 100. The front hand portion may be hollow. The first end of the front handle portion 110 may be open and may receive the tool head attachment 200.

The tool head attachment 200 may include a first actuator 330. The front handle portion 110 may include one or more additional openings 111 to access the first actuator 330. In some examples, the tool head attachment 200 may be received and the first actuator 330 accessed through a single opening 101. In the example shown, the tool head attachment 200 includes a blade holder with a single blade.

The rear handle portion 120 may form a second end of the handle 100, opposite to the first end. The rear handle portion 120 may be hollow. The rear handle portion 120 may include an end cap 140. The end cap 140 may be fixed in position or may be removable to access an interior of the handle 100 e.g. for changing one or more batteries.

The interior of the handle 100 may include one or more electronic components, for example, a power source, a charging interface, a circuit board, a controller, a motor, a user input, an indicator etc. The power source may include a fixed power pack, a DC input connection or a changeable battery. The charging interface may be a wired or wireless interface arranged at or near the end cap 140, e.g. a wireless charging coil positioned within the end cap 140. The motor may be connected with a clipper or shaver attachment and/or equipped with a vibration function. The user input may include one or more buttons to interact with the controller e.g. to activate the motor and or set a power level of the motor, e.g. corresponding to a level of vibration. The indicator may include one or more lights and/or displays and/or sound output to provide information for the user e.g. to indicate an active state, or a battery level of the tool.

The front handle portion 110 may be fixedly attached to the rear handle portion 120. The outer grip 130 may be formed in one or more portions and arranged to fit around one or both of the front and rear handle portions 110,120. Other suitable handle configurations may be contemplated by a personal skilled in the art.

FIG. 4 is a lateral section schematic of a first end of the personal hygiene tool 1. The opening 101 may be formed with a curved inner wall. A cross-section profile of the curved inner wall may be formed as a section of a circle. A plurality of recesses 102 are formed within the opening 101. The plurality of recesses 102 may be formed in the inner wall of the opening 101.

The tool head attachment 200 comprises a latching mechanism 300. The latching mechanism 300 comprises a sliding latch 310 and a resiliently deformable element 320. The sliding latch 310 is slideable between an extended position and a retracted position. The sliding latch 310 may be an elongate element slideable along its length in a plane perpendicular the second axis.

The tool head attachment 200 may include an attachment frame 210. The attachment frame 210 may be configured to support an attached tool head and support the latching mechanism 300 within the opening 101 of the housing. The attachment frame 210 may be generally circular. The attachment frame 210 may be positioned to abut with the curved inner wall to rotate within the opening 101. In the extended position the sliding latch 310 may protrude beyond the circular extent of the attachment frame 210. In the extended position the sliding latch 310 protrudes into one of the plurality of recesses 102. In the retracted position the sliding latch 310 is disengaged from the recesses 102.

The sliding latch 310 may have a forward end where the sliding latch 310 engages with the handle 100, and a rear end where the sliding latch 310 engages with the resiliently deformable member. The resiliently deformable element 320 is arranged to urge the sliding latch 310 towards the extended position. The resiliently deformable member may be arranged at the rear end of the sliding latch 310. The resiliently deformable member may be arranged between the sliding latch 310 and a compression surface. The compression surface may be formed by an inner wall of the tool head attachment 200.

When the sliding latch 310 is in the extended position, the resiliently deformable element 320 may be fully or almost fully expanded. When the sliding latch 310 is in the retracted position, the resiliently deformable element 320 may be fully or almost fully compressed. The resiliently deformable element 320 may be a metallic or plastic spring e.g. a coil spring, wave spring or disc spring, or may be a deformable block formed of e.g. foam, gel, or deformable plastic material.

The latching mechanism 300 comprises a first actuator (not shown). The first actuator is configured to urge the sliding latch 310 towards the retracted position against the resiliently deformable element 320.

In this way, the tool head attachment 200 of the personal hygiene tool 1 can be rotated between a number of fixed positions, which allows the tool to be used in a variety of different positions. In this way, the ergonomics and usability of the tools can be improved. A user can rotate the tool head attachment 200 into the position which is most comfortable and most stable for the desired task. For example, where the personal hygiene tool 1 is implemented as a shaver, the shaver head can be rotated between a normal longitudinal position to a right-angled position for improved stability in a fine detailing task. Where the tool head is replaceable, the tool head attachment may be rotated to the most suitable position for the task of the attached tool head, e.g. to a right angled position for a dermaplaning tool head.

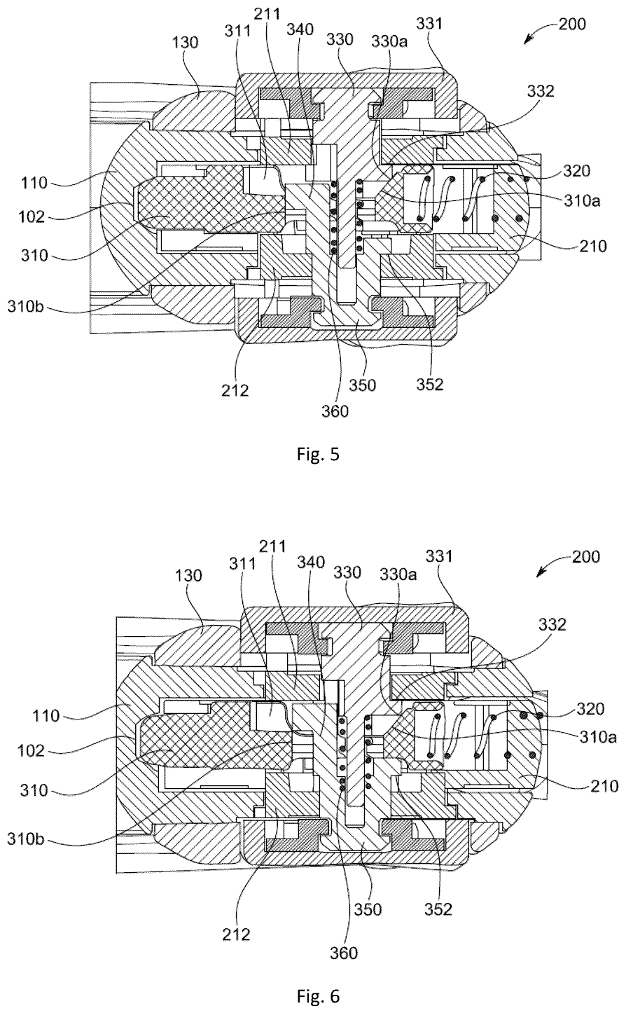

FIG. 5 is a longitudinal section schematic of the first end of the personal hygiene tool 1. FIG. shows the front handle portion 110, the outer grip 130 of the handle 100 and the tool head attachment 200. The tool head attachment 200 may include the attachment frame 210, the sliding latch 310, the resiliently deformable element 320 and the first actuator 330. The attachment frame 210 may include an upper latch support 211 and a lower latch support 212. The sliding latch 310 may be held in position between the upper latch support 211 and the lower latch support 212.

The first actuator 330 may include a user-depressible button 331 movable along the second axis. The first actuator 330 may be supported by the upper latch support 211. As shown, the user may apply a downwards force to move the button 331 and the first actuator 330 downwards along the second axis. FIG. 5 shows a first state where the button 331 of the first actuator 330 is not pressed.

The first actuator 330 may include a camming surface 330a set at an angle to a movement direction of the first actuator 330. The camming surface 330a may be set at 45 degrees to the second axis. The camming surface 330a may be arranged to engage with the sliding latch 310.

The sliding latch 310 may have a reaction surface 310a set at an angle to the second axis. The reaction surface 310a may be set at 45 degrees to the second axis. The reaction surface 310a may be angled towards the forward direction of the sliding latch 310. The camming surface 330a and reaction surface 310a may be in contact in the first state where the button 331 of the first actuator 330 is not pressed. The resiliently deformable element 320 may be in an expanded state in the first state where the button 331 of the first actuator 330 is not pressed.

The personal hygiene tool 1 may include a blocker 340 which is engageable with the sliding latch 310 in the extended position to prevent the sliding latch 310 from moving towards the retracted position. The sliding latch 310 may include a blocking surface 310b which is in contact with the blocker 340 when the sliding latch 310 is in the extended position. The blocking surface 310b may face towards the rear end of the sliding latch 310 and may be prevented from moving in the rearwards direction by the blocker 340. As shown, the blocker 340 may be arranged in a central recess of the sliding latch 310 and the blocking surface 310b may be an inner surface of the recess. In some examples, the blocking surface 310b may be formed at the rear end of the sliding latch 310 or formed in an external recess e.g. formed in one side of the sliding latch 310.

FIG. 6 is a longitudinal section schematic of the first end of the personal hygiene tool 1.

The personal hygiene tool 1 may include a second actuator 350 configured to move the blocker 340 from an engaged position where the blocker 340 is engaged with the sliding latch 310 to a disengaged position where the blocker 340 is disengaged from the sliding latch 310. The blocker 340 may be formed as a part of the second actuator 350. In some examples, the second actuator 350 may be a separate component arranged to engage with and move the blocker 340.

The second actuator 350 may include a user-depressible button 351 movable along the second axis, where an activation direction of each actuator is along the second axis towards the other actuator. The second actuator 350 may be supported by the lower latch support 212. As shown, the user may apply an upwards force to move the button 351 and the second actuator 350 upwards along the second axis. FIG. 6 shows a second state where the button 351 of the second actuator 350 is pressed and the button 331 of the first actuator 330 is not pressed.

The button 351 of the second actuator 350 may be moved a distance of 0.8 mm inwards. In some examples, the distance moved by the button 351 of the second actuator 350 may be between 0.1 mm and 5 mm. The distance moved by the button 351 of the second actuator 350 may be greater or lesser than this range, as required.

As shown, the blocker 340 may be moved out of the engaged position by the second actuator 350. The blocker 340 may be moved upwards from the engaged position to the disengaged position. An upper side of the sliding latch 310 may include a recess 311 aligned with the blocker 340 when the blocker 340 is in the disengaged position such that the sliding latch 310 can move in the rearward direction without making contact with the blocker 340. In some examples, the blocker 340 in the disengaged position may be moved beyond the upper side of the sliding latch 310.

The blocker 340 may be moved upwards towards the first actuator 330. The first actuator 330 may have a recess to allow movement of blocker 340 in an upwards direction without making contact with the first actuator 330. By providing the arrangement of the blocker 340 and the second actuator 350, the tool head attachment 200 can be rotated by simultaneous actuation of the first actuator button 331 and the second actuator button 351. This can prevent accidental unlatching leading to unintended rotation of the tool head attachment 200. The arrangement of the first actuator 330 and second actuator 350 allows the respective actuator buttons 331,351 to be squeezed by the user e.g. by a finger and thumb pinch.

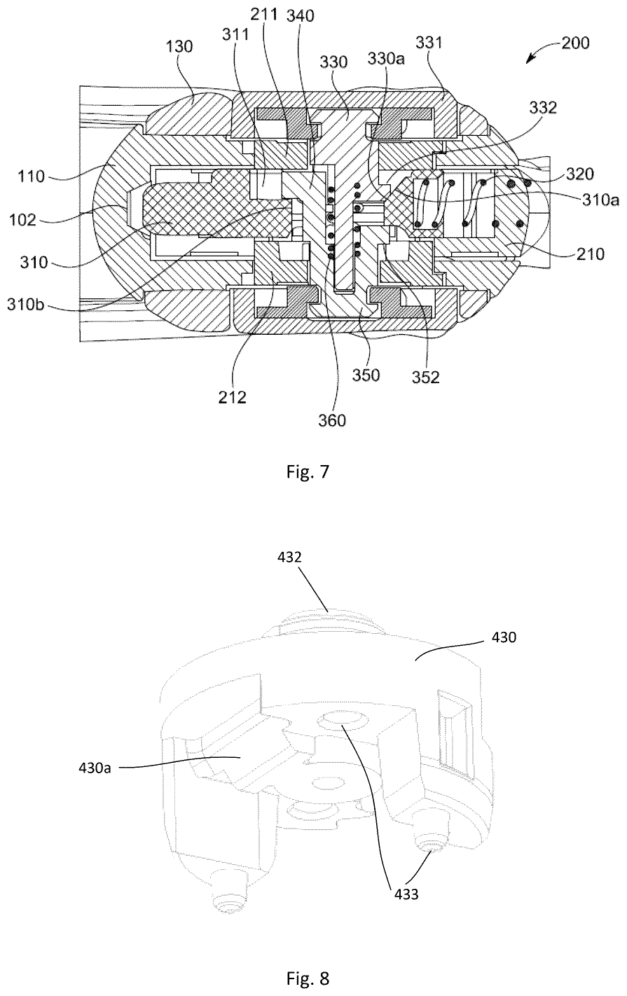

FIG. 7 is a longitudinal section schematic of the first end of the personal hygiene tool 1.

The camming surface 330a may urge the sliding latch 310 in a direction perpendicular to the movement direction of the first actuator 330. The sliding latch 310 may be moved in a rearward direction when the blocker 340 is in the disengaged position. FIG. 7 shows a third state where the button 351 of the second actuator 350 is pressed and the button 331 of the first actuator 330 is also pressed.

The button 331 of the first actuator 330 may be moved a distance of 0.8 mm inwards. In some examples, the distance moved by the button 331 of the first actuator 330 may be between 0.1 mm and 5 mm. The distance moved by the button 331 of the first actuator 330 may be greater than this range to provide greater security or less than this range to improve usability or user convenience.

The first actuator 330 may be moved downwards towards the second actuator 350. The recess of the first actuator 330 may allow movement of the first actuator 330 in a downwards direction without making contact with the blocker 340 of the second actuator 350.

The resiliently deformable element 320 may be in a partially or fully compressed state in the third state where the button 331 of the first actuator 330 is pressed. The sliding latch 310 may be moved a distance of 0.5 mm out of the recess 102 in the third state. In some examples, the distance moved by the sliding latch 310 may be between 0.1 mm and 5 mm. The distance moved by the button 351 of the second actuator 350 may be greater than this range to provide greater security or less than this range to improve usability or user convenience. In some examples, the sliding latch 310 may be urged to the retracted position where the sliding latch 310 is disengaged from the recesses 102.

In some examples, the first actuator 330 may be configured to urge the sliding latch 310 to a point between the extended position and the retracted position where the sliding latch 310 is partially engaged with one of the plurality of recesses 102. In this position, the sliding latch 310 may be moved between recesses 102 under a rotational force applied by the user, and the user can receive a tactile sensation and/or an audible click when the sliding latch 310 moves into each recess 102.

An outer edge of each recess 102 and a protruding end of the sliding latch 310 may be bevelled or rounded. An extent of the interference between the sliding latch 310 and the recess 102 in the third state may be 0.2 mm. The sliding latch 310 may be moved a further 0.2 mm under a rotational force applied by the user to move between recesses 102. In some examples, the extent of the interference may be between 0.1 mm and 2 mm. The extent of the interference may be greater than this range to provide greater security or less than this range to improve usability or user convenience.

In another embodiment, the first actuator may be formed in a single piece with the upper latch support. The second actuator may be formed in a single piece with the lower latch support.

FIG. 8 is a perspective view of a first actuator 430 according to a second embodiment. Components of the second embodiment not described in detail may be substantially the same as the first embodiment. The first actuator 430 may include a protrusion 432 for connecting a user-depressible button. The user may apply a downwards force to move the button and the first actuator 430 downwards along the second axis.

The first actuator 430 may include a camming surface 430a set at an angle to a movement direction of the first actuator 430. The camming surface 430a may be set at 45 degrees to the second axis. The camming surface 430a may be arranged to engage with the sliding latch 410.

The first actuator 430 may include one or more interlocking elements 433. The interlocking elements 433 may be arranged to interlock with elements of a second actuator 450, when the first actuator 430 is adjacent to the second actuator 450.

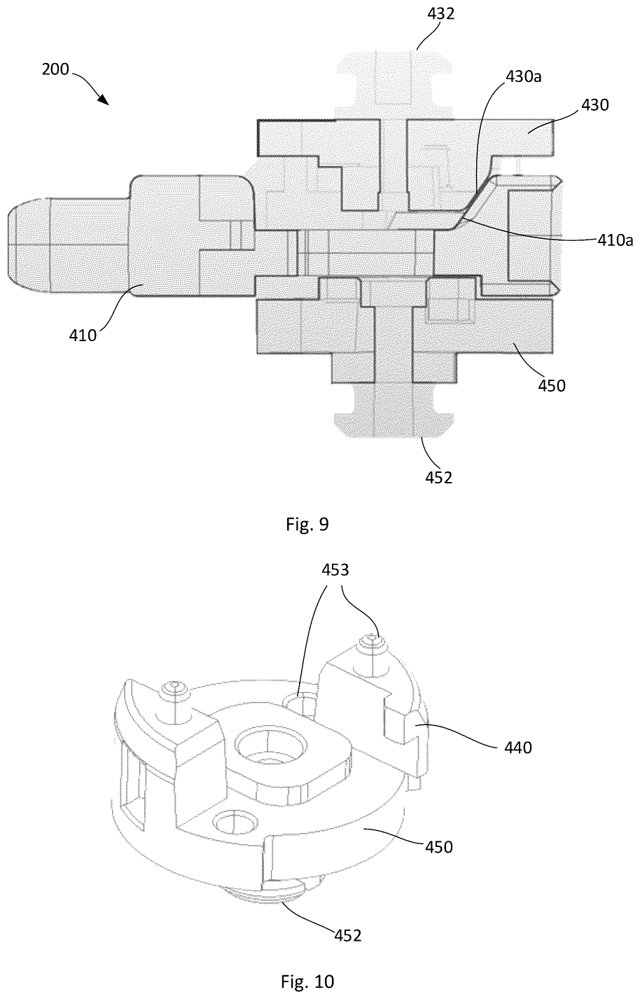

FIG. 9 is a longitudinal section schematic of the first end of the personal hygiene tool 1′, according to the second embodiment. As shown, the personal hygiene tool 1′ may include the first actuator 430, the second actuator 450 and a sliding latch 410.

The sliding latch 410 may have a reaction surface 410a set at an angle to the second axis. The reaction surface 410a may be set at 45 degrees to the second axis. The reaction surface 410a may be angled towards the forward direction of the sliding latch 410. The camming surface 430a and reaction surface 410a may be in contact in the first state where the button of the first actuator 430 is not pressed.

FIG. 10 is a perspective view of the second actuator 450 according to the second embodiment. The second actuator 450 may include a protrusion 452 for a user-depressible button. The user may apply an upwards force to move the button and the second actuator 450 upwards along the second axis.

The second actuator 450 may be configured to move a blocker 440 from an engaged position where the blocker 440 is engaged with the sliding latch 410 to a disengaged position where the blocker 440 is disengaged from the sliding latch 410. The blocker 440 may be formed as a part of the second actuator 450.

The second actuator 450 may include one or more interlocking elements 453. The interlocking elements 453 may be arranged to interlock with interlocking elements 433 of the first actuator 430, when the first actuator 430 is adjacent to the second actuator 450.

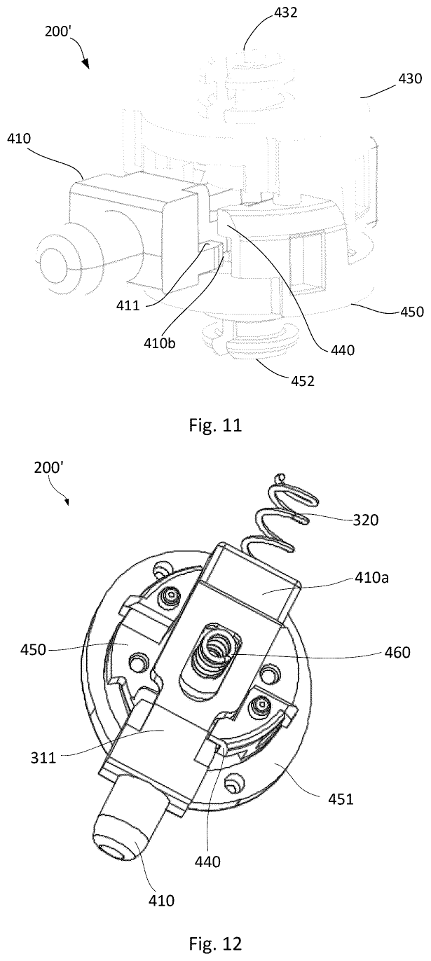

FIG. 11 is a perspective view of the first end of the personal hygiene tool 1′, according to the second embodiment.

The blocker 440 may be engageable with the sliding latch 410 in the extended position to prevent the sliding latch 410 from moving towards the retracted position. The sliding latch 410 may include a blocking surface 410b which is in contact with the blocker 440 when the sliding latch 410 is in the extended position. The blocking surface 410b may face towards the rear end of the sliding latch 410 and may be prevented from moving in the rearwards direction by the blocker 440. As shown, the blocker 440 may be formed in an external recess e.g. formed in one side of the sliding latch 410.

As shown, the blocker 440 may be moved out of the engaged position by the second actuator 450. The blocker 440 may be moved upwards from the engaged position to the disengaged position. The sliding latch 410 may include a recess 411 aligned with the blocker 440 when the blocker 440 is in the disengaged position such that the sliding latch 410 can move in the rearward direction without making contact with the blocker 440.

By providing the arrangement of the blocker 440 and the second actuator 450, the tool head attachment can be rotated by simultaneous actuation of the first actuator button 432 and the second actuator button 452. This can prevent accidental unlatching leading to unintended rotation of the tool head attachment. The arrangement of the first actuator 430 and second actuator 450 allows the respective actuator buttons 432,452 to be squeezed by the user e.g. by a finger and thumb pinch.

FIG. 12 is a partially disassembled view of a tool head attachment 200 of the personal hygiene tool 1′ according to the second embodiment. As shown, the tool head attachment 200 includes the sliding latch 410, the resiliently deformable element 320, the second actuator 450 and a button 451 of the second actuator 450.

The sliding latch 410 may be supported by the second actuator 450, or the lower latch support 212 in the first embodiment. The first actuator 430 or the upper latch support 211 may be arranged to fit over the sliding latch 410 and attach to the second actuator.

The protruding end of the sliding latch 410 may have a circular form. The plurality of recesses 102 in the housing may have a corresponding circular form. The resiliently deformable element 320 may be arranged at the rear end of the sliding latch 410.

The second actuator 450 may be fixed to rotate with the sliding latch 410. The first actuator 430 may be fixed to rotate with the sliding latch 410.

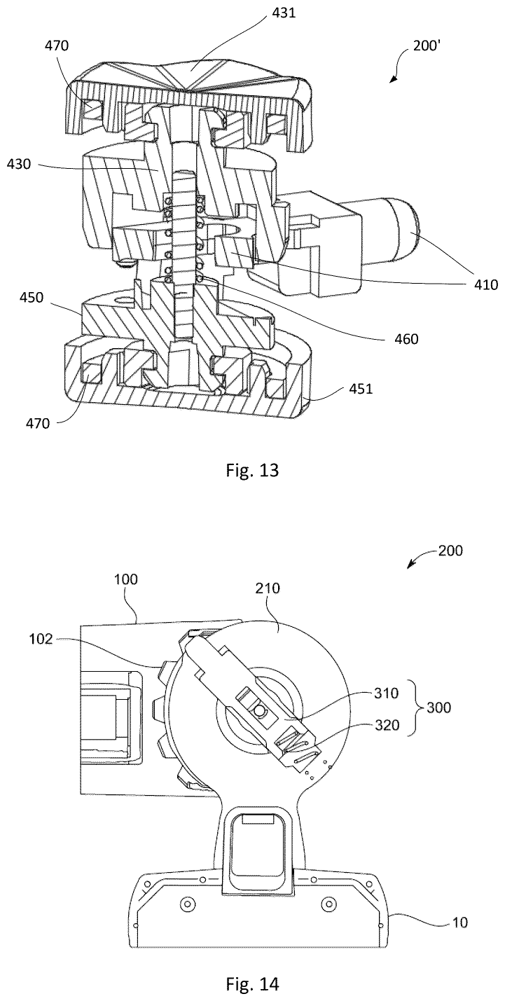

FIG. 13 is an oblique section schematic of the tool head attachment 200′ of the personal hygiene tool 1′ according to the second embodiment. As shown, the tool head attachment 200′ includes the button 451 of the second actuator 450, the second actuator 450, the sliding latch 410, the first actuator 430 and the button 431 of the first actuator 430.

The personal hygiene tool 1′ may include a second resiliently deformable element 460 arranged between the first actuator 430 and the second actuator 450 to resist movement in the respective activation direction of each actuator. In this way, the arrangement of the first and second actuators 430,450 can be constructed without an intermediate portion of the attachment frame 210 fixed between the actuators 430,450, and with only a single resiliently deformable element 460. This can simplify construction and reduce the number of components required.

The buttons 431,451 may be fixed to rotate with the respective actuators 430,450. In some examples, the buttons 431,451 may be free to rotate with respect to the respective actuators 430,450. In this way, the user's first hand can remain in position while the other hand rotates the attachment frame 210.

One or more magnets 470 may be arranged within the button 431 of the first actuator 430 or the button 451 of the second actuator 450. The magnets 470 may allow the personal hygiene tool 1′ to be fixed in position e.g. in a case.

FIG. 14 is a lateral section schematic of the first end of the personal hygiene tool 1.

As shown, the sliding latch 310 may be urged to a point between the extended position and the retracted position where the sliding latch 310 is partially engaged with one of the plurality of recesses 102.

The plurality of recesses 102 may be arranged in an arc extending in a plane perpendicular the second axis. The handle 100 may include five recesses 102 spaced equally apart. In some examples, the number of recesses 102 may be greater or less than five.

The tool head attachment 200 may define a third axis extending between the second axis and a working point of the tool. The sliding latch 310 may be arranged to extend at 45 degrees to the third axis. The arrangement can allow the tool head attachment 200 to be rotated from a starting position aligned with the first axis to a right-angled position, while the recesses 102 are equally spaced around the first axis.

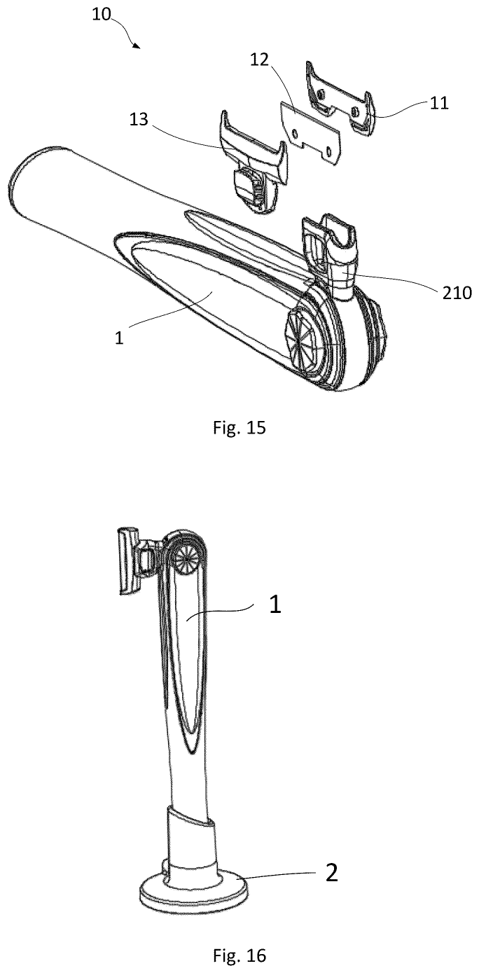

FIG. 15 is a partially disassembled view of a blade holder 10 of the personal hygiene tool 1. The blade holder 10 may include a frame 11, one or more blades 12 and a cover 13.

The frame 11 may include an engaging element configured to engage with a corresponding receiving portion on the attachment frame 210 of the tool head attachment 200. The engaging element may include a depressible element which can be depressed as the blade holder 10 is engaged with the tool head attachment 200 and engages with the receiving portion of the attachment frame 210 to resist removal of the blade holder 10. The depressible element may be arranged to be pressed by the user to disengage from the receiving portion and remove the blade holder 10 from the tool head attachment 200.

The frame 11 may include a recessed area shaped to receive the one or more blades 12. The recessed area may include one or more protrusions configured to engage with the blades 12. The one or more blades 12 may be formed with one or more through holes configured to receive the protrusions of the frame. The blades may be formed from stainless steel or any other suitable material. The cover 13 may be configured to attach to the frame 11 with the blades 12 between. The cover 13 may be configured to attach to the protrusions of the frame 11 to fix the blades 12 in position.

FIG. 16 is a perspective view of the personal hygiene tool 1 with a charging base 2. The handle 100 may be formed from metal or plastic materials. In some examples, the front handle portion 110, rear handle portion 120 and end cap 140 may be formed from stainless steel or anodised aluminium. The outer grip 130 may be formed from rubber, rubberised or rubber-coated plastic.

The tool head attachment 200 may be formed from plastic or machined metal components e.g. machined aluminium.

The charging base 2 is formed to support the personal hygiene tool 1 thereon and provide power to the personal hygiene tool 1. The charging base 2 may be configured to support the handle 100 of the personal hygiene tool 1 in a vertical orientation. The charging base 2 may include an opening 21 configured to receive the rear handle portion 120 of the personal hygiene tool 1. The charging base 2 may be configured to charge the personal hygiene tool 1 when the personal hygiene tool 1 is supported by the charging base 2.

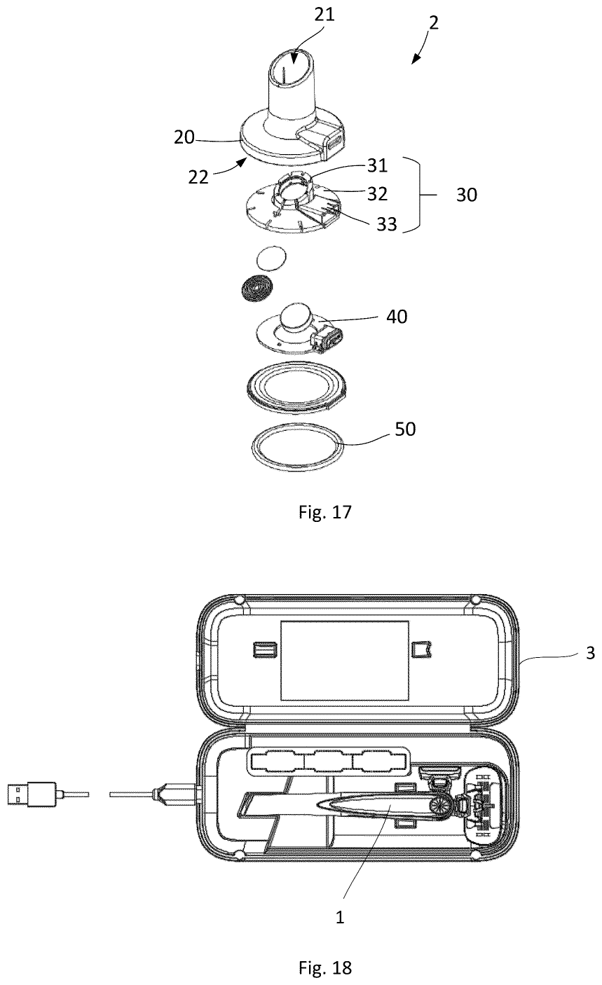

FIG. 17 is a disassembled view of the charging base 2. The charging base 2 may include a housing 20, charging assembly 30, bottom cover 40 and friction ring 50.

The housing 20 may be formed with an upper cavity 21 and a lower cavity 22. The upper cavity 21 may be open to an upper side of the housing 20 and may be configured to receive the rear handle portion 120 of the personal hygiene tool 1. The upper cavity 21 may be shaped to correspond with the rear handle portion 120 and end cap 140 of the handle 100. For example, the upper cavity 21 may be formed with a sloped floor to abut with an angled end cap 140 of the handle 100. The upper cavity 21 may be formed with a drainage hole through to the lower cavity 22.

The lower cavity 22 may be open to a lower side of the housing 20 and may be configured to receive the charging assembly 30. The charging assembly 30 may include a wireless charging coil 31, a PCB 32, and a charging port 33. The wireless charging coil 31 may be arranged adjacent to the upper cavity 21 to interface with a corresponding charging coil in the handle 100 of the personal hygiene tool 1. The PCB 32 may be connected to the wireless charging coil 31 and charging port 33 and may include a controller to manage charging of the personal hygiene tool 1. The charging port 33 may be a USB port e.g. a USB-C port. The housing 20 may include a side opening aligned with the charging port 33 for access thereto.

The bottom cover 40 may be arranged to cover the lower cavity 22. The bottom cover 40 may be formed with a drainage hole aligned with the drainage hole of the upper cavity 21. The bottom cover 40 may include a ring-shaped groove to retain the friction ring 50. The friction ring 50 may be formed of rubber, rubberised plastic or silicone and may be arranged on the bottom cover 40 to prevent the charging base 2 from slipping.

FIG. 18 is a plan view of the personal hygiene tool 1 with a charging case 3. The charging case 3 is formed to hold the personal hygiene tool 1 inside and provide power to the personal hygiene tool 1. The charging case 3 may be configured to support the personal hygiene tool 1 in a horizontal orientation. The charging case 3 may include a charging groove 71 configured to receive the rear handle portion 120 of the personal hygiene tool 1. The charging case 3 may be configured to charge the personal hygiene tool 1 when the personal hygiene tool 1 is supported within the charging case 3. The charging case 3 may be configured to sterilise the blade holder 10 of the personal hygiene tool 1 when the personal hygiene tool 1 is supported within the charging case 3.

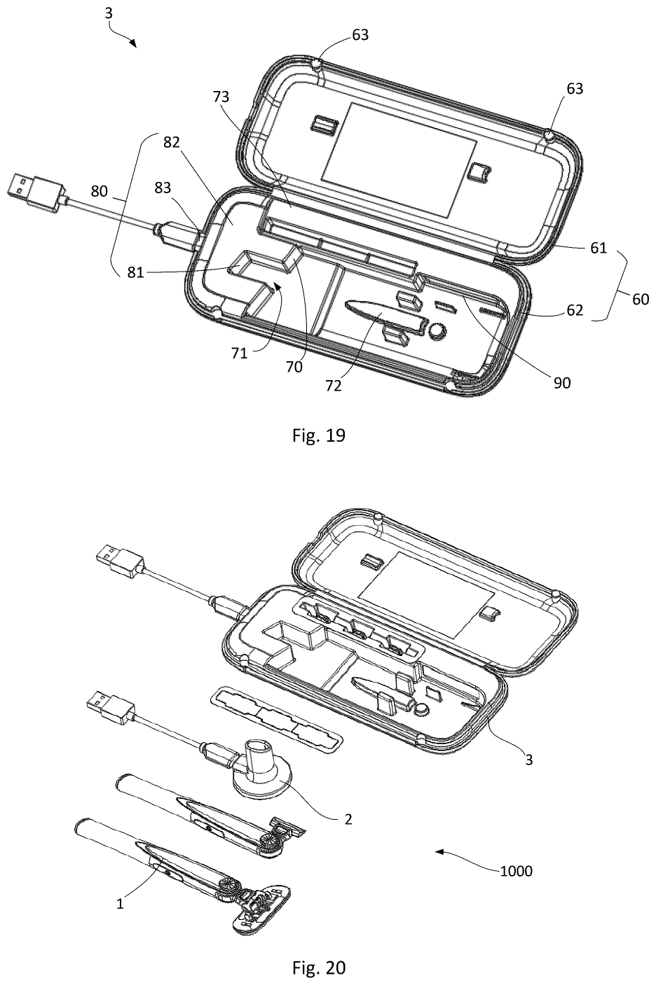

FIG. 19 is a disassembled view of the charging case 3. The charging case 3 may include a housing 60, an inner shell 70, a charging assembly 80 and a sterilising assembly 90. The housing 60 may be formed from an upper shell 61 and a lower shell 62. The upper shell 61 and lower shell 62 may be attached with a hinge along one side to form a clamshell. One or both of the upper shell 61 and lower shell 62 may include one or more magnets to keep the housing 60 closed. The upper shell 61 and lower shell 62 may be formed from plastic. An outer surface of the upper shell 61 and lower shell 62 may be rubberised or rubber coated.

The inner shell 70 may be formed to support the personal hygiene tool 1 within the housing 60.

The inner shell 70 may include a charging groove 71 configured to receive the rear handle portion 120 of the personal hygiene tool 1. The inner shell 71 may also include a retaining groove 72 configured to position the handle 100 of the personal hygiene tool 1. One or more positioning magnets may be arranged within or beneath the inner shell 70 to hold the handle 100 in position.

The inner shell 70 may include a blade holding area 73 formed to hold one or more additional blade cartridges. The inner shell 70 include an area for the charging assembly 80 and an area for the sterilising assembly 90.

The charging assembly 80 may include a wireless charging coil 81, a PCB 82, a charging port 83, and a battery 84. The wireless charging coil 81 may be arranged adjacent to the charging groove 71 to interface with a corresponding charging coil in the handle 100 of the personal hygiene tool 1. The PCB 82 may be connected to the wireless charging coil 81 and charging port 83 and may include a controller to manage charging of the personal hygiene tool 1.

The charging port 83 may be a USB port e.g. a USB-C port. The lower shell 62 may include a side opening aligned with the charging port 83 for access thereto. If a power source is connected to the charging port 83, the controller of the PCB 82 may be configured to charge the personal hygiene tool 1 and charge the battery 85 when the personal hygiene tool 1 is fully charged. If a power source is not connected to the charging port 83, the controller of the PCB 82 may be configured to charge the personal hygiene tool 1 using the battery 85.

The sterilising assembly 90 may include one or more sterilising LEDs 91 and a Hall sensor 92. The LEDs 91 may be ultraviolet (UV) LEDs, e.g. UV-C LEDs, arranged near the blade holder 10 of the personal hygiene tool 1 when the handle 100 is correctly positioned in the housing 60.

The Hall sensor 92 may be mounted on the PCB 82 or elsewhere on the inner shell 70 and may be aligned with a magnet in the upper shell 61. In this way, the Hall sensor 92 can detect whether the housing 60 is open or closed. The controller of the PCB 82 may be configured to activate the LEDs 91 when the housing 60 is closed and deactivate the LEDs when the housing 60 is open.

FIG. 20 is a perspective view of a personal hygiene system 1000 including the personal hygiene tool 1, as well as the charging base 2 and/or charging case 3.

The above embodiments are described by way of example only. Many variations are possible without departing from the scope of the disclosure as defined in the appended claims.

For clarity of explanation, in some instances the present technology may be presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A personal hygiene tool comprising:
a handle extending along a first axis and comprising an opening formed at a first end, where a plurality of recesses are formed within the opening; and
a tool head attachment at least partially retained within the opening and rotatable with respect to the handle around a second axis;
wherein the tool head attachment comprises a latching mechanism comprising:
a sliding latch slideable between an extended position where the sliding latch protrudes into one of the plurality of recesses and a retracted position where the sliding latch is disengaged from the recesses;
a resiliently deformable element arranged to urge the sliding latch towards the extended position; and
a first actuator configured to urge the sliding latch towards the retracted position against the resiliently deformable element.

2. The personal hygiene tool of claim 1, wherein the first actuator comprises a user-depressible button movable along the second axis.

3. The personal hygiene tool of claim 1, wherein the first actuator comprises a camming surface set at an angle to a movement direction of the first actuator, and the camming surface is arranged to engage with the sliding latch and urge the sliding latch in a direction perpendicular to the movement direction of the first actuator.

4. The personal hygiene tool of claim 1, wherein the sliding latch is an elongate element slideable along its length in a plane perpendicular the second axis.

5. The personal hygiene tool of claim 1, wherein an outer edge of each recess and a protruding end of the sliding latch are bevelled or rounded, and
wherein the first actuator is configured to urge the sliding latch to a point between the extended position and the retracted position where the sliding latch is partially engaged with one of the plurality of recesses.

6. The personal hygiene tool of claim 1, wherein the plurality of recesses and a protruding end of the sliding latch have a circular form.

7. The personal hygiene tool of claim 1, further comprising a blocker which is engageable with the sliding latch in the extended position to prevent the sliding latch from moving towards the retracted position.

8. The personal hygiene tool of claim 7, further comprising a second actuator configured to move the blocker from an engaged position where the blocker is engaged with the sliding latch to a disengaged position where the blocker is disengaged from the sliding latch.

9. The personal hygiene tool of claim 8, wherein the second actuator comprises a user-depressible button movable along the second axis, where an activation direction of each actuator is along the second axis towards the other actuator.

10. The personal hygiene tool of claim 9, further comprising an second resiliently deformable element arranged between the first actuator and the second actuator to resist movement in the respective activation direction of each actuator.

11. The personal hygiene tool of claim 1, wherein the plurality of recesses are arranged in an arc extending in a plane perpendicular the second axis.

12. The personal hygiene tool of claim 1, wherein the tool head attachment defines a third axis extending between the second axis and a working point of the tool, and the sliding latch is arranged to extend at 45 degrees to the third axis.

13. The personal hygiene tool of claim 1, wherein the second axis is perpendicular to the first axis.

14. The personal hygiene tool of claim 1, wherein the tool is a shaver, trimmer or scraper, and the tool head attachment comprises a blade or blade assembly.

15. A personal hygiene system comprising the personal hygiene tool of claim 1, and at least one of:
a charging base formed to support the personal hygiene tool thereon and provide power to the personal hygiene tool; and
a charging case formed to hold the personal hygiene tool inside and provide power to the personal hygiene tool.
